(19) United States
(12) Patent Application Publication
(10) Pub. No.: US 2017/0031694 A1
(43) Pub. Date: Feb. 2, 2017

(54) SYSTEM AND METHOD FOR REMOTE SYSTEM CONFIGURATION MANAGMENT

(71) Applicant: Quanta Computer Inc., Taoyuan City (TW)

(72) Inventors: Hung-Lu CHU, Taoyuan City (TW); Chin-Fu TSAI, Taoyuan City (TW); Yung-Fu LI, Taoyuan City (TW)

(21) Appl. No.: 14/853,109

(22) Filed: Sep. 14, 2015

Related U.S. Application Data
(60) Provisional application No. 62/198,406, filed on Jul. 29, 2015.

(51) Int. Cl. G06F 9/44; G06F 9/445

(52) U.S. Cl. CPC G06F 9/4416; G06F 9/44505

(57) ABSTRACT

Embodiments generally relate to updating a basic input/output system (BIOS) configuration in a computing system. The present technology discloses techniques that that can enable a remote BIOS configuration updating using a shared storage device between a service controller and a BIOS. By enabling an out-of-band management protocol, the present technology can achieve a remote and efficient BIOS management method.

### CROSS-REFERENCE TO RELATED APPLICATIONS

This application claims priority to U.S. Provisional Application No. 62/198,406, filed Jul. 29, 2015, and entitled “SYSTEM AND METHOD FOR REMOTE SYSTEM CONFIGURATION MANAGEMENT”, the contents of which are hereby incorporated by reference in its entirety for all purposes.

### FIELD OF THE INVENTION

The disclosure relates generally to system configuration update in a computing system.

### BACKGROUND

A basic input/output system (BIOS) is a firmware that can ensure a system's computing components are functional. The BIOS stores firmware that is executed when the computer system is first powered on, along with a set of configurations specified for the BIOS. The BIOS typically recognizes, initializes, and tests hardware in a computing system.

For example, the BIOS can first execute a power on self test (POST) and then load the operation system (OS). The BIOS can also provide an interface that allows a variety of different parameters to be set. Particularly, the BIOS can specify clock and bus speeds and other parameters that affect performance of the computer system. The BIOS can finally transfer control of the computer system to an operating system. The BIOS configurations can be stored in a non-volatile memory (e.g., a non-volatile random-access memory (NVRAM)) or a read-only memory (ROM).

The BIOS sometimes needs to be updated to ensure the proper functions of a computer system. For example, the BIOS needs to be updated to coordinate with a newly added processor, or the BIOS needs to be updated when there is a bug detected in the BIOS.

### SUMMARY

Aspects of the present technology relate to techniques that enable a remote BIOS configuration updating by using a shared storage device between a service controller and a Basic Input Output System (BIOS). By enabling a network-based protocol, the present technology can achieve a remote and efficient BIOS management method. The present technology can also enable an out-of-band server management when the main server is powered off or unavailable.

In accordance with one aspect of the present invention, a computer-implemented method is provided, including: booting up a computing device, receiving, at a service controller of the computing device, an updated basic input/output system configuration from a remote management device, storing, by the system controller, the updated basic input/output system configuration to a storage device configured to be shared between the service controller and a basic input/output system of the computing device, retrieving, by the service controller, the updated basic input/output system configuration in the storage device, and transmitting, by the service controller, the updated basic input/output system configuration to the remote management device.

In accordance with another aspect of the present invention, a non-transitory computer-readable storage medium storing instructions is provided, the instructions when executed by a service controller causing the service controller to: receive, at a storage device configured to be shared between a service controller and a Basic Input Output System (BIOS), store the updated basic input/output system configuration in the storage device, receive, at the service controller, a basic input/output system configuration request from a remote management device, retrieve, by the service controller, the updated basic input/output system configuration in the storage device; and transmit the updated basic input/output system configuration to the remote management device.

According to some embodiments, a service controller, e.g. baseboard management controller (BMC), can be utilized to remotely update the BIOS configuration when a computing device associated with the BMC is powered off or unavailable. A BMC can establish a dedicated network interface with a remote management device regardless of the main processor's operation status. The BMC can receive an updated BIOS configuration from a remote management device via a dedicated network interface (e.g., a local area network). The BMC can store the updated BIOS configuration in a shared storage device between the BMC and the BIOS of the computing device via a system interface (e.g, a PCIe bus). When the computing device is booted up, the BIOS can identify the updated BIOS configuration in the shared storage device and retrieve the updated BIOS configuration, which can, for example, update BIOS configuration to initiate a booting process of the computing device. Additionally, other service controllers, such as a Rack Management Controller (RMC), can be utilized to remotely update the BIOS configuration.

According to some embodiments, a service controller can provide a copy of the updated BIOS configuration to a remote management device. For example, the BMC can retrieve the updated BIOS configuration from the storage device configured to be shared by the BMC and the BIOS. Additionally, the BMC can transmit the updated BIOS configuration to a remote management device via, for example, a LAN.

According to some embodiments, a storage device can be configured to be shared by a service controller and a BIOS. The storage device can be any storage medium configured to store program instructions or data for a period of time. It can be a shared memory between the service controller and the BIOS. According to some embodiments, the storage device can be a flash drive, a random access memory (RAM), a non-volatile random-access memory (NVRAM), a read-only memory (ROM), an electrically erasable programmable read-only memory (EEPROM), or a mailbox register.

Although many of the examples herein are described with reference to utilizing a BMC, it should be understood that these are only examples and the present technology is not limited in this regard. Rather, any service controller that is independent from the BIOS can be utilized to remotely update the BIOS configuration.

Additionally, even though the present disclosure uses remote management control protocol (RMCP) or intelligent platform management bus/bridge (IPMB) as examples approach of how to transmit data between different devices/components, the present technology is applicable to other protocols that can handle the data transmission described herein.

Additional features and advantages of the disclosure will be set forth in the description which follows, and, in part, will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

### BRIEF DESCRIPTION OF THE DRAWINGS

Various embodiments or examples (“examples”) of the invention are disclosed in the following detailed description and the accompanying drawings:

FIG. 1 is a schematic block diagram illustrating an example of a remote BIOS configuration management system, according to some embodiments;

FIG. 2 is an example flow diagram for a remote BIOS configuration management system, according to some embodiments;

FIG. 3 is another example flow diagram for a remote BIOS configuration management system, according to some embodiments; and

FIG. 4 illustrates a computing platform of a computing device, according to some embodiments.

### DETAILED DESCRIPTION

Various embodiments of the present technology are discussed in detail below. While specific implementations are discussed, it should be understood that this is done for illustration purposes only. A person skilled in the relevant art will recognize that other components and configurations may be used without departing from the spirit and scope of the present technology.

The BIOS is an important system component that is responsible for initializing and testing hardware components of a computing system. The BIOS can provide an abstraction layer for the hardware thereby providing a consistent way for applications and operating systems to interact with a peripheral device such as a keyboard, a display, and other input/output devices.

For example, the BIOS can run system check prior to booting up the operating system (OS), e.g., the Microsoft Windows® OS, the Linux® OS, or any operating system. System check is a diagnostic system examination executed during initialization of a computing device. A Power-On Self-Test (POST) is an example of system check. The major functions of POST are handled by the BIOS, which may assign some of these duties to other programs designed to initialize specific peripheral devices, such as video and small computer system interface (SCSI) initialization. The principal functions of the BIOS during POST include verifying CPU registers and the integrity of the BIOS code, checking basic components, examining system main memory, and passing control to other specialized BIOS extension. POST can also be configured to discover, initialize, and catalog all system buses and devices, provide a user interface for system's configuration, and construct a system environment required by the operating system.

The BIOS configuration frequently needs to be updated. For example, the BIOS configuration is set by the manufacture. For customized requirement, users need to reconfigure the BIOS configuration.

Conventional techniques for updating the BIOS configuration include using console redirection. However, these conventional techniques are not efficient when there is a large number of BIOS configuration need to be updated. e.g., in a data center. For example, for the console redirection, the BIOS needs to execute a specific program (e.g, an BIOS Setup Utility) to configure the BIOS configuration. For a large number of computing devices, such conventional approaches are not user friendly and not efficient.

Thus, there is a need to provide a remote BIOS management system that can offer flexible and efficient BIOS configuring. According to some embodiments, the present technology can enable a remote BIOS updating by sharing a storage device between a service controller and a BIOS. Particularly, aspects of the present technology can improve the efficiency of the BIOS configuration update. Because the service controller can connect to a remote management device via a network, it can eliminate the inflexibility caused by console redirection or other similar techniques. Further, aspects of the present technology can enable an out-of-band system configuration update when the main CPU is powered off.

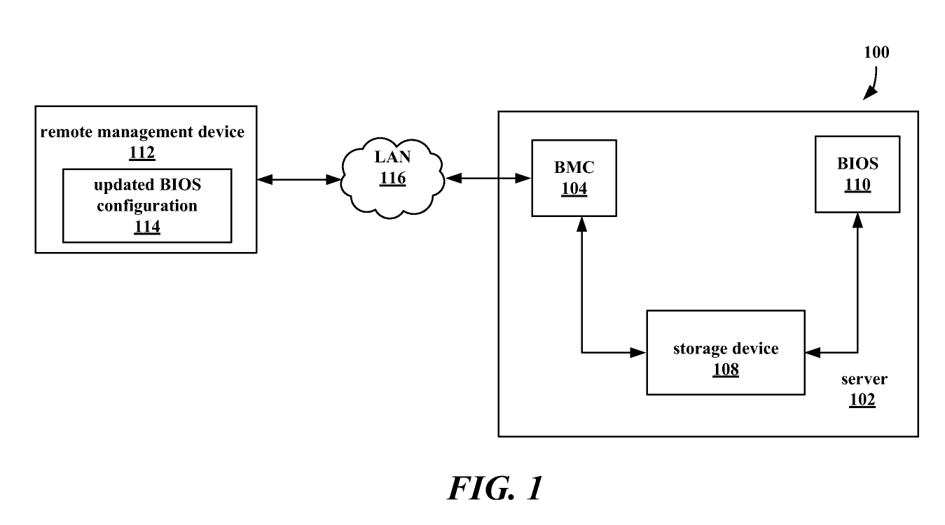

FIG. 1 is a schematic block diagram illustrating an example of a remote BIOS configuration management system, according to some embodiments. It should be appreciated that the topology in FIG. 1 is an example, and any numbers of servers, remote management device and system components may be included in the system of FIG. 1.

A remote BIOS configuration management system 100 can include, for example, remote management device 112 and server 102. According to some embodiments, server 102 can include BMC 104 (baseboard management controller), BIOS 110 and storage device 108. Additionally, server 102 can include a network interface controller (not shown) for network connection and a main processor (not shown). For purpose of this disclose, server 102 can be any computing device operable to compute and process any form of data. For example, server 102 can be a personal computer, a network storage device, a network computing device. Server 102 can additionally include, for example, various input/output devices such as a display, one or more storage devices such as redundant array of independent disks (RAID), and one or more network interface controllers (NICs). Server 102 can communicate with remote management device 112 via a wired network connection such as Ethernet, or a wireless network connection such as LAN 116 (local area network) or a wide area network.

Remote management device 112 can be any suitable computing device that can be used by a system administrator to manage a server. For example, remote management device 112 can be a personal computer, a tablet, or a web-based system. As shown in FIG. 1, Remote management device 112 can store, in a storage medium, updated BIOS configuration 114. Updated BIOS configuration 114 can be executed by the BIOS to update BIOS configuration.

As illustrated in FIG. 1, server 102 can include one or more service controllers such as BMC 104. A BMC is an independent and embedded microcontroller that, in some embodiments, is responsible for the management and monitoring of the main central processing unit (e.g., processor) and peripheral devices on the motherboard (e.g., switches, computing nodes and storage nodes). According to some embodiments, BMC 104 can communicate with remote management device 112 via a dedicated network interface (e.g., a LAN) implemented by an associated network interface controller (not shown). BMC 104 can communicate with storage device 108 via memory-mapped I/O interfaces.

BMC 104 can implement out-of-band management when server 102 is powered off or unavailable. An out-of-band management can use a dedicated channel for managing network devices. For example, BMC 104 can communicate with remote management device 112 via Remote Management Control Protocol (RMCP) or RMCP+ for Intelligent Platform Management Interface (IPMI) over LAN.

Storage device 108 can be any storage medium configured to store program instructions or data for a period of time. Storage device 108 can be a shared memory between BMC 104 and BIOS 110, which can be coupled to BIOS 110 or BMC 104. Storage device 108 can also be an independent storage device. According to some embodiments, storage device 108 can be a flash drive, a random access memory (RAM), a non-volatile random-access memory (NVRAM), a read-only memory, an electrically erasable programmable read-only memory (EEPROM), or a mailbox register. Storage device 108 can be configured to store the system configurations such as BIOS data.

BIOS 110 can be any program instructions or firmware configured to initiate and identify various components of server 102, including device such as a keyboard, a display, a data storage, and other input or output devices.

As shown in FIG. 1, remote management device 112 can store updated BIOS configuration 114 and send it to BMC 104 via a network interface. For example, remote management device 112 can send updated BIOS configuration 114 data to BMC 104 via a network interface such as RMCP+ over LAN. Updated BIOS configuration 114 can include, for example, a BIOS default configuration. According to some embodiments, server 102 is powered off when remote management device 112 sends updated BIOS configuration 114 to BMC 104.

After receiving updated BIOS configuration 114, BMC 104 can send updated BIOS configuration 114 to storage device 108, which can be shared by BMC 104 and BIOS 110. According to some embodiments, BMC 104 can send updated BIOS configuration 114 to storage device 108, for example, via memory-mapped I/O interface messages. Storage device 108 can store updated BIOS 114 after receiving it.

When server 102 is booting up, BIOS 110 can access updated BIOS configuration 114 stored in storage device 108 and execute updated BIOS configuration 114 to initialize server 102. In addition, BIOS 110 can also use updated BIOS configuration 114 to update BIOS 110 configuration

According to some embodiments, storing updated BIOS configuration 114 in storage device 108 can enable BMC 104 to remotely provide a copy of the updated BIOS configuration to a remote management device. For example, a server administrator can issue a BIOS configuration data request through remote management device 112. Remote management device 112 can send the BIOS configuration data request to BMC 104, via a network, for example, using RMCP+ over LAN. After receiving the BIOS configuration data request, BMC 104 can retrieve updated BIOS configuration 114 stored at storage device 108, for example, via memory-mapped I/O interface messages. According to some embodiments, BMC 104 can send a request to storage device 108 via memory-mapped I/O interface messages. In response to the request, storage device 108 can send updated BIOS configuration 114 to BMC via memory-mapped I/O interface messages.

BMC 104 can further transmit updated BIOS configuration 114 to remote management device 112 via RMCP+ over LAN. According to some embodiments, BMC 104 can provide updated BIOS configuration 114 to remote management device 112 when server 102 is powered off.

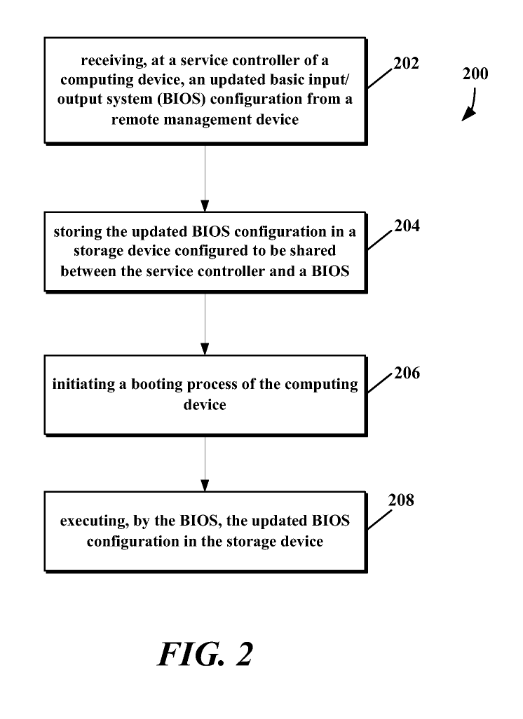

FIG. 2 is an example flow diagram for a remote BIOS configuration management system, according to some embodiments. It should be understood that there can be additional, fewer, or alternative steps performed in similar or alternative orders, or in parallel, within the scope of the various embodiments unless otherwise stated.

At step 202, a service controller of a computing device can receive an updated BIOS configuration 114 from a remote management device. For example, as shown in FIG. 1, remote management device 112 can send updated BIOS configuration 114 data to BMC 104 using a network interface such as RMCP+ over LAN. Updated BIOS configuration 114 can include, for example, a BIOS default configuration. According to some embodiments, server 102 is powered off when remote management device 112 sends updated BIOS configuration 114 to BMC 104.

At step 204, the service controller can store the updated BIOS configuration to a storage device configured to be shared between the service controller and BIOS 110. For example, BMC 104 can send updated BIOS configuration 114 to storage device 108, which can have a shared access between BMC 104 and BIOS 110. According to some embodiments, BMC 104 can send updated BIOS configuration 114 to storage device 108. Storage device 108 can store updated BIOS 114 after receiving it.

Storage device 108 can be any storage medium configured to store program instructions or data for a period of time. Storage device 108 can be a shared memory between BMC 104 and BIOS 110, which can be coupled to BIOS 110BMC 104. Storage device 108 can also be an independent storage device. According to some embodiments, storage device 108 can be a flash drive, a RAM, a NVRAM, a ROM, an EEPROM, or a mailbox register. Storage device 108 can be configured to store the system configurations such as BIOS data.

At step 206, the computing device associated with the service controller can initiate a booting process. For example, server 102 can be powered up after a command issued from remote management device 112.

At step 208, BIOS 110 can access the updated BIOS configuration 114 in the shared storage medium. For example, BIOS 110 can access updated BIOS 114 in storage device 108 and execute updated BIOS configuration 114 to initialize server 102.

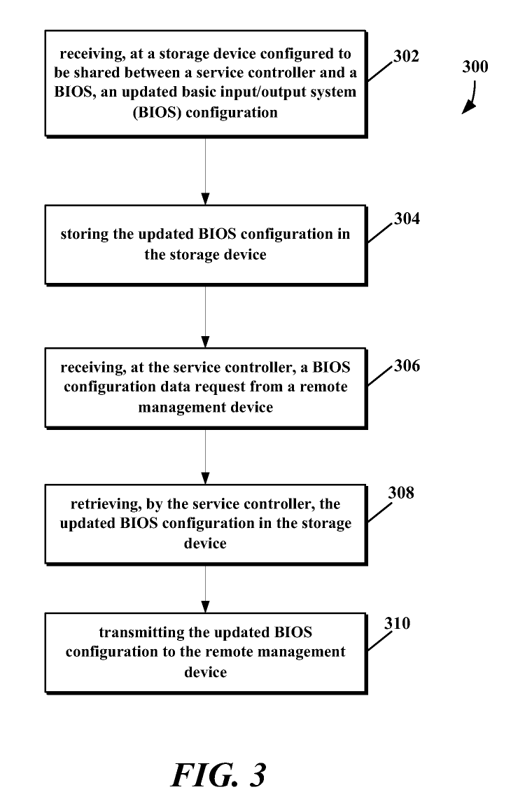

FIG. 3 is another example flow diagram for a remote BIOS configuration management system, according to some embodiments. It should be understood that there can be additional, fewer, or alternative steps performed in similar or alternative orders, or in parallel, within the scope of the various embodiments unless otherwise stated.

At step 302, a shared storage device between a service controller and a BIOS can receive an updated BIOS configuration. For example, as illustrated in FIG. 1, storage device 108 can receive updated BIOS configuration 114 from BMC 104. According to some embodiments, server 102 can be powered off when storage device 108 receives the updated BIOS configuration 114 from BMC 104.

At step 304, the storage device can store the updated BIOS configuration.

At step 306, a service controller can receive a BIOS request from a remote management device. For example, a server administrator can issue a BIOS configuration data request through remote management device 112 via a user interface. Remote management device 112 can send the updated BIOS configuration data request to BMC 104, via a network, for example, using RMCP+ over LAN.

At step 308, the service controller can retrieve the updated BIOS configuration from the storage device. For example, BMC 104 can send a request to storage device 108. In response to the request, storage device 108 can send updated BIOS configuration 114 to BMC 104.

At step 310, the service controller can transmit the updated BIOS configuration to the remote management device. For example, BMC 104 can further transmit updated BIOS configuration 114 to remote management device 112 via RMCP+ over LAN. According to some embodiments, BMC 104 can provide updated BIOS configuration 114 to remote management device 112 when server 102 is powered off.

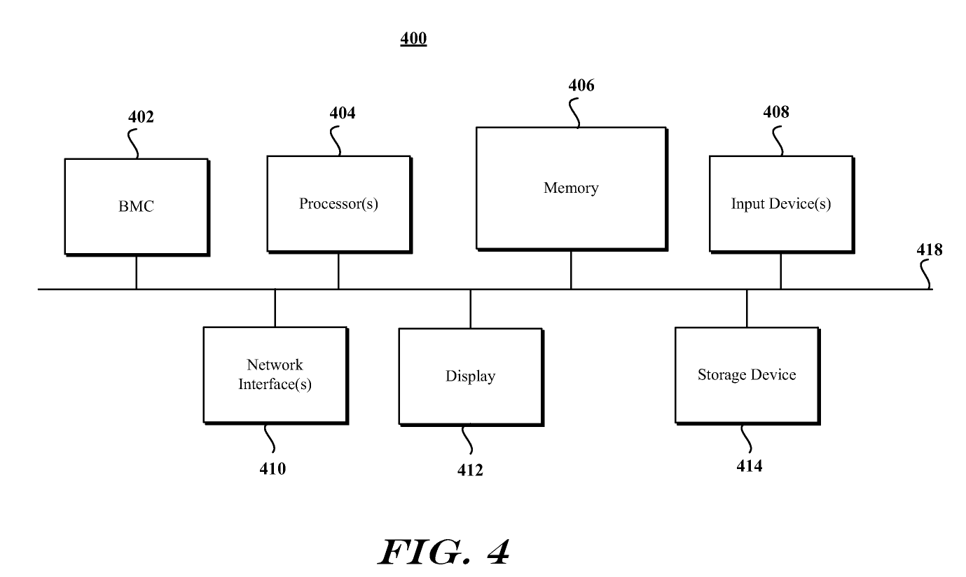

FIG. 4 illustrates an example system architecture 400 for implementing the systems and processes of FIGS. 1-3. Computing platform 400 includes a bus 418 which interconnects subsystems and devices, such as: BMC 402, processor 404, memory 406, input device 408, network interfaces 410, display 412 and storage device 414. Processor 404 can be implemented with one or more central processing units (“CPUs”), such as those manufactured by Intel® Corporation—or one or more virtual processors—as well as any combination of CPUs and virtual processors. Computing platform 400 exchanges data representing inputs and outputs via input-and-output devices input devices 408 and display 412, including, but not limited to: keyboards, mice, audio inputs (e.g., speech-to-text devices), user interfaces, displays, monitors, cursors, touch-sensitive displays, LCD or LED displays, and other I/O-related devices.

According to some examples, computing architecture 400 performs specific operations by processor 404, executing one or more sequences of one or more instructions stored in memory 406. Computing platform 400 can be implemented as a server device or client device in a client-server arrangement, peer-to-peer arrangement, or as any mobile computing device, including smart phones and the like. Such instructions or data may be read into memory 406 from another computer readable medium, such as a storage device. In some examples, hard- wired circuitry may be used in place of or in combination with software instructions for implementation. Instructions may be embedded in software or firmware. The term “computer readable medium” refers to any tangible medium that participates in providing instructions to processor 404 for execution. Such a medium may take many forms, incl6uding, but not limited to, non-volatile media and volatile media. Non-volatile media includes, for example, optical or magnetic disks and the like. Volatile media includes dynamic memory, such as memory 406.

Common forms of computer readable media includes, for example: floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 418 for transmitting a computer data signal.

In the example shown, memory 406 can include various software programs that include executable instructions to implement functionalities described herein. In the example shown, memory 406 includes a log manager, a log buffer, or a log repository—each can be configured to provide one or more functions described herein.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed is:

1. A computer-implemented method, comprising:
booting up a computing device;
receiving, at a service controller of the computing device, an updated basic input/output system configuration from a remote management device;
storing, by the system controller, the updated basic input/output system configuration to a storage device configured to be shared between the service controller and a basic input/output system of the computing device;
retrieving, by the service controller, the updated basic input/output system configuration in the storage device; and
transmitting, by the service controller, the updated basic input/output system configuration to the remote management device.

2. The computer-implemented method of claim 1, further comprising:
retrieving, by the basic input/output system, the updated basic input/output system configuration in the storage device;
setting, by the basic input/output system, a basic input/output system configuration with the updated basic input/output system configuration; and
storing, by the basic input/output system, the update basic input/output system configuration to the storage device.

3. The computer-implemented method of claim 2, wherein the service controller of the computing device is configured to receive the updated basic input/output system configuration when the computing device is powered down.

4. The computer-implemented method of claim 1, wherein the service controller is configured to receive the updated basic input/output system configuration via remote management control protocol messages.

5. The computer-implemented method of claim 2, wherein the service controller is configured to transmit the updated basic input/output system configuration to the storage device via memory-mapped I/O interface messages.

6. The computer-implemented method of claim 2, wherein retrieving, by the basic input/output , the updated basic input/output system configuration further comprises:
identifying the updated basic input/output system configuration in the storage device.

7. The computer-implemented method of claim 1, wherein the storage device is at least one of being intendent or being coupled to one of the service controller or the basic input/output system.

8. The computer-implemented method of claim 1, wherein the storage device is at least one of a flash drive, a non-volatile random-access memory, a read-only memory, an electrically erasable programmable read-only memory, or a mailbox register.

9. A system, comprising:
a processor; and
a memory device including instructions that, when executed by the processor, cause the processor to:
receive, by a basic input output system, an updated basic input/output system configuration from a remote management device;
store the updated basic input/output system configuration in a storage device configured to be shared between a service controller and the basic input output system; and
initiate a booting process of the system.

10. The system of claim 9, wherein the system is powered off when receiving the updated basic input/output system configuration from the remote management device.

11. The system of claim 9, wherein the service controller is configured to receive the updated basic input/output system configuration via remote management control protocol messages.

12. The system of claim 9, further comprising instructions that, when executed by the system, cause the system to:
identify the updated basic input/output system configuration in the storage device.

13. The system of claim 9, wherein the basic input/output system is configured to access the updated basic input/output system configuration via a system interface.

14. A non-transitory computer-readable storage medium storing instructions, which, when executed by a processor, cause the processor to perform at least one of operations comprising:
receiving, at a storage device configured to be shared between a service controller and a basic input output system, an updated basic input/output system configuration;
storing the updated basic input/output system configuration in the storage device;
receiving, at the service controller, a basic input/output system configuration request from a remote management device;
retrieving, by the service controller, the updated basic input/output system configuration in the storage device; and
transmitting the updated basic input/output system configuration to the remote management device.

15. The non-transitory computer-readable storage medium of claim 14, wherein the service controller is configured to receive the basic input/output system configuration request from the remote management device via remote management control protocol messages.

16. The non-transitory computer-readable storage medium of claim 14, wherein the service controller is configured to retrieve the updated basic input/output system configuration in the storage device via memory-mapped I/O interface messages.

17. The non-transitory computer-readable storage medium of claim 14, wherein the service controller is configured to retrieve the updated basic input/output system configuration in the storage device when a computing device is powered off.

18. The non-transitory computer-readable storage medium of claim 14, which cause the processor to further perform one of operations comprising:
sending, by the service controller, a request for the updated basic input/output system configuration to the storage device; and
receiving the updated basic input/output system configuration from the storage device.

19. The non-transitory computer-readable storage medium of claim 14, which cause the processor to further perform one of operations comprising:
identifying the updated basic input/output system configuration in the storage device.

20. The non-transitory computer-readable storage medium of claim 14, wherein the service controller is configured to receive the updated basic input/output system configuration via remote management control protocol messages.
